(19) United States
(12) Patent Application Publication
(10) Pub. No.: US 2008/0211203 A1
(43) Pub. Date: Sep. 4, 2008

(54) Vehicle Propulsion System

(76) Inventor: Peter Thir, LaPlata, MD (US)

Correspondence Address: W. MICHAEL COOPER;ATTORNEY AT LAW, P.O. BOX 519, HOLLYWOOD, MD, 20636, US

(21) Appl. No.: 11/681,538

(22) Filed: Mar. 2, 2007

(51) Int. Cl. B62M 1/00; B62M 23/00

(52) U.S. Cl. 280/230; 280/210

(57) ABSTRACT

This invention discloses a lever operated vehicle propulsion system wherein the levers move substantially horizontally and couplers are adjusted along each lever to control the mechanical advantage available to the vehicle operator. Drive chains that are attached to each coupler and engage a pair of freewheel sprockets that, in turn, engage an axle or hub that is attached to a drive wheel. The free ends of the drive chains are connected together by a tensioning device to maintain tension in the drive chains. Also disclosed is a power transmission device that may be used to engage or disengage a drive wheel of a three or four wheeled vehicle from the drive axle.

### CROSS REFERENCE TO RELATED APPLICATIONS

Not Applicable.

### FEDERALLY SPONSORED RESEARCH

Not Applicable.

### SEQUENCE LISTING OR PROGRAM

Not Applicable.

### BACKGROUND

This invention relates to human-powered vehicle propulsion systems, such as those used on bicycles and three and four wheeled human-powered vehicle designs.

Most contemporary bicycle (and other pedal-driven vehicle) designs employ a drive sprocket that is coupled to a vehicle frame in such a way that the sprocket's axis is fixed relative to the frame. Two cranks are coupled to the sprocket; one on each side. The cranks extend radially in opposite directions away from the axis of the sprocket. A pedal is pivotally attached to the opposite end of each crank. The operator is located over the pedals and exerts alternating input forces downward against each pedal using the operators' feet. When the sprocket is positioned so that a pedal is forward of the axis of the sprocket, then the component of the downward input force that is perpendicular to the crank acts to develop torque around the sprocket. This torque rotates the sprocket. Usable power is developed by the speed of rotation of the sprocket and this torque. Therefore, one of the efficiencies of the system may be judged by determining the percentage of the operator's input force that is used to develop this torque.

The pedal moves in a circular pattern with respect to the vehicle frame. Only that component of the input force that is perpendicular to the crank acts to develop the torque that drives the wheel. Viewing the traditional bicycle from the operator's right side and starting with the right pedal at the top of its revolution, the input force is parallel to the crank. Though the operator is exerting force, there is no the torque developed. During typical operation, the momentum of the elements in the propulsion system will move the pedal through this position. As the pedal moves forward, the component of the input force that is perpendicular to the crank increases. It is not until the pedal and crank are about 40° from the starting position that more than a significant amount of the input force, about 75 percent, acts to develop torque. The pedal is forced downward through a point where the input force is perpendicular to the crank the maximum amount of input force acts to develop torque. As the pedal continues to rotate clockwise, the amount of the input force used to develop torque decreases. At about 140° from the starting position, this efficiency decreases below about 75 percent. When the pedal is at the bottom of its circular pattern, the input force is again parallel with the crank and no torque is created. Little, if any, force is applied on the return stroke to develop torque. Any force exerted upwardly by the operator is countered by the weights of the pedal assembly and the operator's body.

Therefore, a significant amount of the input force exerted by the operator acts to develop useable torque for only about 100° of the 360° of a pedal's rotation. One series of attempts to develop a more efficient transfer of the force exerted by the operator has incorporated the use of levers. The levers typically isolate a portion of the power stroke wherein the input force is substantially perpendicular to the lever. Examples of lever-operated designs may be found in U.S. Pat. No. 6,554,309 to Thir, U.S. Pat. No. 7,011,376 to Sepulveda, U.S. Pat. No. 5,785,337 to Ming, and U.S. Pat. No. 4,574,649 to Seol. However, each of these references suffers from one or more of the following disadvantages:

a. additional weight created by additional components,

b. lack of adequate shifting mechanisms,

c. failure to truly maximize the transmission of force,

d. significant energy is lost to the extension of tensioner springs,

e. lack of ability to maximize the force developed, and

f. greater manufacturing and maintenance costs created by additional components.

For the foregoing reasons, there is a need for a robust, efficient, lever-operated propulsion system that may be manufactured and maintained cost effectively.

### SUMMARY

I claim a vehicle propulsion system having two pedal arm assemblies, each connected pivotally to a vehicle frame so that the force generated by the operator is substantially perpendicular to each pedal arm assembly during the power stroke. Each pedal arm assembly includes a coupler. The position of each drive coupler may be adjusted along the pedal arm to change the mechanical advantage used by the vehicle operator. Each coupler is connected to a drive chain and each drive chain engages the teeth of each of two drive sprockets, respectively. A tensioner cable is connected to the free end of each drive chain and travels around an idler pulley to maintain tension in the drive chains. The system requires few sprockets and idler pulleys, thus decreasing the manufacturing and maintenance costs and increasing system reliability. The system may be used on bicycles or vehicles with more than two wheels. These vehicles may include a seat with a seat back that allows the operator to develop greater forces against the pedals than achievable with contemporary designs.

### DESCRIPTION OF THE DRAWINGS

FIG. 1 shows a bicycle with the propulsion system claimed.

FIG. 2 is a detailed view of the elements of the claimed propulsion system.

FIG. 3 shows a bicycle with the propulsion system claimed, including the drive chain housing.

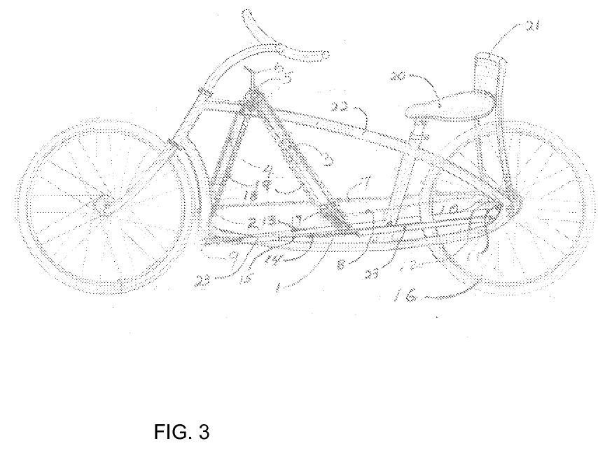

FIG. 4 shows a three wheeled vehicle with the propulsion system claimed.

FIG. 5 shows a claimed power transmission system that may be used on vehicles with a drive axle to allow the vehicle to be moved backward without binding the drive chains of the propulsion system.

### DESCRIPTION OF REFERENCE NUMERALS

1 First Pedal

2 Second Pedal

3 First Pedal Arm

4 Second Pedal Arm

5 Pivot

6 Crank

7 Second Drive Chain

8 First Drive Chain

9 Idler Pulley

10 Second Drive Sprocket

11 First Drive Sprocket

12 Hub

13 Second Drive Chain Connector

14 First Drive Chain Connector

15 Tensioner Cable

16 Drive Wheel

17 First Drive Coupler

18 Second Drive Coupler

19 Shifting Chain

20 Seat

21 Seat Back

22 Vehicle Frame

23 Drive Chain Housing

101 Drive Axle

102 Engaging Shaft

103 Engaging Arm

104 Engaging Arm Slot

105 Engaging Plate Channel

106 Engaging Plate

107 Engaging Dowel

108 Axle Flange

109 Dowel Guide Sleeve

110 Drive Wheel Hub Flange

111 Engagement Holes in Drive Wheel Hub Flange

112 Drive Wheel Hub

### DETAILED DESCRIPTION

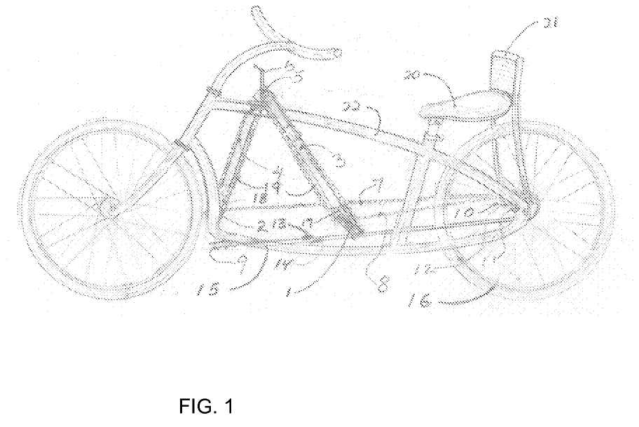

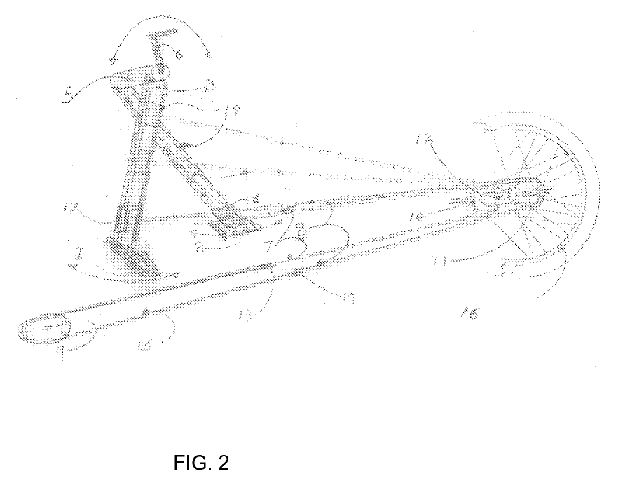

This invention is intended to be used to propel human-powered vehicles, such as bicycles. The vehicle frame 22 is part of the vehicle and is not claimed. The vehicle may include two or more wheels. There are several conventional designs available to the public for three and four wheeled human-powered vehicles. As shown in FIGS. 1 and 2, the propulsion system includes a first pedal arm 3 on the left side of the vehicle frame 22 and a second pedal arm 4 on the opposite side of the vehicle frame 22. At one end, the pedal arms 3, 4 are pivotally attached to the frame of the vehicle. This pivot 5 may be facilitated by any of several various available bearing and bushing designs. Pedals 1, 2 are attached to the other end of each pedal arm 3, 4, providing the operator interface. Drive couplers 17, 18 are attached to each pedal arm 3, 4 in such a way that the position of each drive coupler 17, 18 may be adjusted along a substantial portion of the length of the respective pedal arm 3, 4. Each drive coupler 17, 18 is attached to a first and a second drive chain 7, 8, respectively. The first drive chain 8 engages the first drive sprocket 11. The second drive chain 7 engages the second drive sprocket 10. Each drive sprocket 10, 11 incorporates conventional freewheel hub technology and freely rotates in one direction without engaging the hub 12 or axle 101 and engages the hub 12 or axle 101 when rotated in the opposite direction. Drive chain connectors 13, 14 are used at the free ends of the drive chains 7, 8 to attach the drive chains to a tensioner cable 15. As each pedal 1, 2 is depressed in turn, the tensioner cable 15 rides back and forth across an idler pulley 9 that is coupled to the vehicle frame. The idler pulley 9 is attached to the vehicle frame 22 and is free to rotate about its axis as the tensioner cable 15 moves.

The pedal arms 3, 4 pivot around a common axis. The connection between the pedal arms 3, 4 and the vehicle frame 22 is facilitated by use of commercially available means such as roller or ball bearings or solid bushings (not shown). The bearings are held in a pivot housing 5 that is attached to the top rail of the vehicle frame by means such as weldment or clamp. The pivot housing 5 is positioned parallel to the axis of the drive wheel 16 or axle (not shown). The pivot housing 5 may be affixed to or incorporated into any point on the vehicle frame that allows the pedal arm to remain substantially perpendicular to the force developed by the operator. Therefore, the pivot may alternatively be located substantially below the pedals 1, 2. This orientation may be preferable in a 3 or 4-wheeled vehicle due to the absence of a top rail in most contemporary vehicle designs. Any method of attachment that allows the pedal arms to pivot around an axis that is fixed with respect to the vehicle frame will meet the inventive concept.

A shaft (not shown) is located along the pivotal axis in the pivot 5 and positioned coaxially with the bearings. A crank 6 is coupled to one end of the shaft allowing the operator to rotate the shaft to a desired position. Two small sprockets (not shown) are attached to the shaft, one over the center of each pedal arm 3, 4. Another small sprocket (not shown), coplanar to the first, is located at the other end of each pedal arm 3, 4. The pedal arms 3, 4 may be manufactured from a square tube, though many shapes could be used, of constant cross-sectional dimension over a significant portion of its length. The drive couplers 17, 18 are short sections of tubing that are only slightly larger than and whose internal cross-sections are similar in shape to the external cross-sections of the respective pedal arms 3, 4. The drive couplers 17, 18 are located on the pedal arms 3, 4 and slide back and forth along the pedal arms 3, 4. A small shifting chain 19 is wrapped around the two sprockets of each pedal arm 3, 4. Each end of the shifting chain 19 is coupled to one side of the respective drive coupler 17, 18 so that the rotation of the crank 6 will slide the drive couplers 17, 18 along the pedal arms 3, 4 and fixing the position of the crank 6 will substantially fix the position of the drive couplers 17, 18 along the pedal arms 3, 4. Incorporating slides of nylon or brass or other suitable material between the coupler and the pedal arm will facilitate the motion of the coupler. U.S. Pat. No. 6,554,309 to Thir discloses a shifting mechanism employing the same theory of operation. There are many shifting methods, however, that will meet the objects of the invention. For instance, threaded couplers could be coupled to threaded rods placed along the center of each pedal arm or couplers could be attached to control rod and cable assemblies. This invention is intended to incorporate any such method of positioning the drive couplers 17, 18 along the length of the pedal arms 3, 4. It is advantageous, but not necessary that the shifting mechanism create the same change in position of both drive couplers 17, 18. For instance, the rotation of the crank 6 moves both drive couplers 17, 18 the same distance along the pedal arms 3, 4. Independent movement of the drive couplers does not make the system unusable and may be provide certain advantages. For instance, if one of the operator's legs is stronger than the other (which is typically the case) the couplers could be adjusted to accommodate. Removing the shifting method from the traditional sprocket cluster has an additional advantage of allowing the operator to change the “gearing” of the vehicle while the vehicle is stopped. On a traditional bicycle, the operator must often make rapid stops in traffic that do not allow sufficient time to change the gearing of the vehicle to a gear ratio appropriate for starting movement again. The operator must then start the movement of the vehicle with a higher than desired gear ratio. The present invention allows the operator to focus on operating the vehicle until the stop is made and then adjust the gear ratio after the vehicle has stopped.

Each drive coupler 17, 18 includes a yoke that is designed to accept the ends of the drive chains 7, 8. The last link of each drive chain 7, 8 is attached to the yoke of the respective drive coupler 17, 18. The drive chains 7, 8 themselves are similar to those used on contemporary bicycle designs.

Each drive chain 7, 8 engages one of two drive sprockets 10, 11. The drive sprockets 10, 11 are located on each side of the hub 12 of the drive wheel 16. Contemporary freewheel and cassette hubs have a freewheel mechanism incorporated into the hub. These hubs incorporate pawls that engage the hub when rotated in one direction and either brake or freewheel in the other direction. The present invention employs this readily available technology. When viewing the vehicle from the operators left side, both drive sprockets 10, 11 engage the hub 12 when the sprocket is rotated in a counterclockwise direction. This allows each drive sprocket 10, 11 to be engaged to the hub 12 when force is exerted on the respective pedal 4, 3.

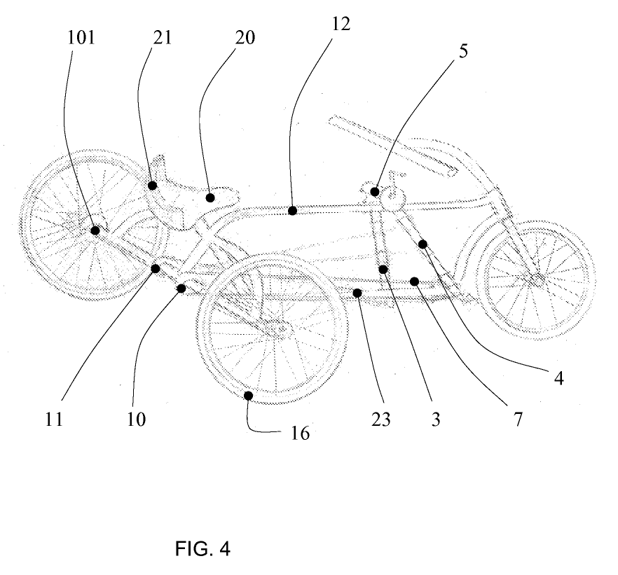

The paragraph above describes the engagement of a drive wheel hub in a two wheeled design. This propulsion system is especially applicable to three and four-wheeled vehicle designs in which the seating positions are often more conventional than a bicycle and the operator is in a more horizontal position. The design requirement to allow the operator maximum control over his body's center of gravity is significantly reduced by the more stable platform. Also, in a seated position, the lever operation is more comfortable that the circular motion required by contemporary designs. FIG. 4 shows a three wheeled design. The drive sprockets 10, 11 engage an axle 101 instead of engaging the hub 12 of the drive wheel 16.

Each drive chain 7, 8 travels around the respective drive sprocket and continues toward the front of the vehicle. Many types of connections may be used to attach the tensioner cable 15 to the ends of each drive chain 7, 8 at the drive chain connectors 13, 14. The preferred embodiment employs a crimped fitting on each end of the tensioner cable 15 that mates with the last link in the end of each drive chain 7, 8. The preferred tensioner cable 15 is constructed of continuous rubber strands with an outer Nylon sheath, like a bungee cord, though other substances may be used.

In the preferred embodiment, two cylindrical plastic drive chain housings 23 are fixedly attached to the vehicle frame 22 and act as guides for the drive chains 7, 8 and tensioner cable 15. The drive chain housings 23 enclose a portion of each drive chain 7, 8, the drive chain connectors 13, 14, and a portion of the tensioner cable 15 between the respective drive sprocket 10, 11 and the idler pulley 9. The drive chain housings 23 allow for minimal tension to be placed on the tensioner cable 15 and prevent the drive chains 7, 8 from accidentally disengaging from the drive sprockets 10, 11. These drive chain housings 23 may be composed of multiple pieces to allow for more efficient maintenance access and housing removal.

In the preferred embodiment, the seat of the vehicle is fixed to the vehicle frame and positioned substantially rearward of the pedal arms 3, 4. The seat 20 has a seat back 21. The operator sits in the seat 20 and places one foot against each pedal 3, 4. The operator presses against the seat back 21 to develop force against each pedal 3, 4 and alternately depresses each pedal 3, 4. The depression of each pedal 3, 4 will cause the other pedal to return to its disengaged position. However, minimal energy is lost to deformation of the tensioner cable 15 because the tensioner cable 15 maintains a substantially constant length during normal operation. The elastic characteristic of the tensioner cable 15 prevents the tensioner cable 15 or the drive chains 7, 8 from accidentally becoming disengaged from the idle pulley 9 or drive sprockets 10, 11 and thus requiring the operator to stop the vehicle and correct the failure.

While doing so increases the energy lost to deformation of the tensioner cable, this design exhibits the additional benefit of decoupling the dependency of the motion of each of the operator's legs. An operator may depress both pedals simultaneously or only use one leg to propel the vehicle.

Mechanical advantage is adjusted by rotating the crank 6. This moves the drive couplers 17, 18 along the respective pedal arms 3, 4. Moving the drive couplers 17, 18 away from pivot 5 will decrease the mechanical advantage of the operator, but move the drive wheel 16 through a greater number or revolutions with each stroke of a pedal arm 3, 4. This setting would be used at higher speeds. Conversely, moving the drive couplers 17, 18 closer to the pivot housing 5 will increase the mechanical advantage. This would be used when starting movement of the vehicle or climbing.

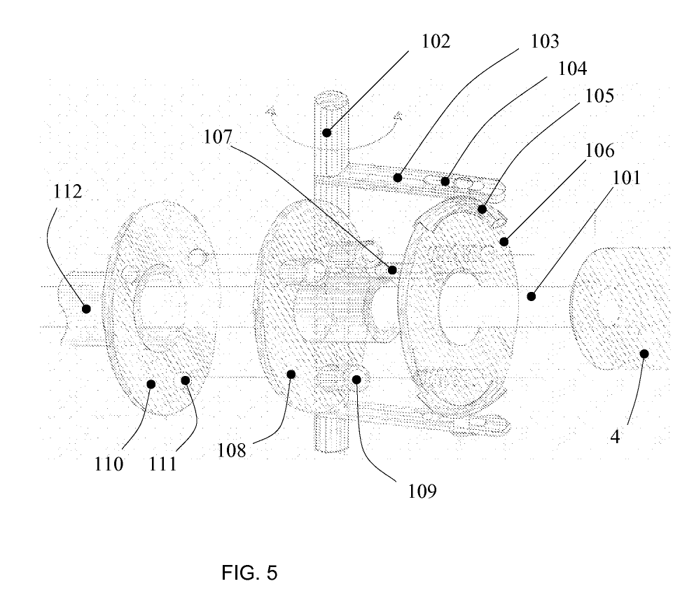

One potential shortcoming of this propulsion system is that some existing freewheeling sprocket designs will not allow the sprocket to disengage from the hub when there is pressure on the sprocket and the vehicle is moved backward. In the present design, rolling the vehicle backwards may pull both drive chains until the pedal arms reached the limit of there travel. Two wheeled designs may easily be picked up or turned around in a small space. Three and four wheeled designs are typically heavier and more difficult to negotiate. FIG. 5 shows a device that may be incorporated to address this concern on three and four wheeled vehicles with a drive axle 101. Operating the device disengages the drive axle 101 from a drive wheel 16. The vehicle may have two drive wheel 16s, one at each end of the drive axle 101, whereby two identical devices would be required. Alternatively, the vehicle may have one drive wheel 16 on one end of the drive axle 101 and a freewheeling wheel on the other end.

The engaging shaft 102 is pivotally attached to the vehicle frame 12. The operator rotates the engaging shaft 102 to operate the device. Two engaging arms 103 are fixedly attached to the engaging shaft 102 so that they swing in an arc when the engaging shaft 102 is rotated. Each engaging arm 103 comprises an elongated engaging arm slot 104. A boss on each of two engaging plate channels 105 rides within each elongated slot 104, respectively. Thus, the engaging plate channels 105 are moved back and forth by the rotation of the engaging shaft 102. The engaging plate channels 105 loosely capture the engaging plate 106. The engaging plate 106 is a rotating disk positioned so that its rotational axis is collinear with the axis of the drive axle 101. A number of engaging dowels 107 project from the outbound face of the engaging plate 106. Fewer dowels may be used, but three is a good balance between manufacturing costs and strength. These dowels 107 ride inside of the corresponding dowel guide sleeves 109 on the axle flange 108. The axle flange 108 is a disk that is welded or otherwise permanently attached to the drive axle 101. Though shown is an exploded view, the dowels 107 are located within the dowel guide sleeves 109 even when the device is in the disengaged configuration. When engaged, the engaging plate 106 is forced toward the drive wheel 16 and the dowels 107 protrude from the outbound side of the axle flange 108 and into engagement holes 111 in the drive wheel hub flange 110. This flange is part of or fixedly attached to the drive wheel hub 112. Only a small space, preferably less than 0.25 inch, separates the drive wheel hub flange 110 from the axle flange 108. The drive wheel hub 112 rides on bearings and is otherwise free to rotate about the drive axle 101. The components are dimensioned such that, when disengaged, the ends of the dowels 107 clear the inbound face of the drive wheel hub flange 110 by less than 0.25 inch. The tolerances between the dowels 107 and the dowel guide sleeves 109 and the engaging holes 111 in the drive wheel hub flange 110 are sufficiently tight to minimize play between the motion of the drive axle 101 and that of the drive wheel 16. Aluminum or steel are the preferred materials to be used in the construction of this device. Though other materials could be used, these materials may be dimensioned to withstand the stresses developed. A friction clutch would be an obvious variation on this design.

Although the description above contains many specificities, these should not be construed as limiting the scope of the invention. Thus, the scope of the invention should be determined by the appended claims and their legal equivalents, rather than by the examples given.

I claim:

1. A vehicle propulsion system, comprising
a. a first and a second pedal arm, each pivotally connected at one end about a single axis, to a vehicle frame,
b. a first and a second drive coupler, each coupled to the first and second pedal arms, respectively,
c. a means for adjusting the position of each drive coupler along a substantial portion of the length of each pedal arm, respectively,
d. a first and a second drive chain, each attached at one end to the first and second drive coupler, respectively,
e. a first and a second drive sprocket, engaged by the first and second drive chain, respectively,
f. a drive wheel pivotally attached to the vehicle frame and coupled to each drive sprocket such that each drive sprocket freely rotates backwards and engages one or more drive wheels when rotated forwards,
g. an elastic tensioner cable connected at each end to the free end of each drive chain, and
h. an idler pulley attached to the vehicle frame and engaged by the elastic tensioner cable such that the elastic tensioner cable maintains tension in the drive chains.

2. A vehicle propulsion system, comprising
a. a first and a second pedal arm, each pivotally connected at one end about a single axis, to a vehicle frame,
b. each pedal arm further comprising
i. a first and a second pedal arm sprocket, each pivotally attached to end of the pedal arm such that the peal arm sprockets are coplanar with each other and the axis of said first pedal arm sprocket is coincident with the axis about which the pedal arm rotates
ii. a shifting chain engaging both pedal arm sprockets, and
iii. a drive coupler coupled to the shifting chain such that rotation of the first pedal arm sprocket moves the drive coupler along a substantial portion of the length of the pedal arm,
c. a crank coupled to the pedal arm sprockets located along the pivotal axis of the pedal arms and rotatable about the pivotal axis of the pedal arms,
d. a first and a second drive chain, each attached at one end to the drive couplers of the first and second pedal arms, respectively,
e. a first and a second drive sprocket, engaged by the first and second drive chain, respectively,
f. a drive wheel pivotally attached to the vehicle frame and coupled to each drive sprocket such that each drive sprocket freely rotates backwards and engages the drive wheel when rotated forwards,
g. an elastic tensioner cable connected at each end to the free end of each drive chain, and
h. an idler pulley attached to the vehicle frame and engaged by the elastic tensioner cable such that the elastic tensioner cable maintains tension in the drive chains.

3. The vehicle propulsion system of claim 1, further comprising
a. a first tubular housing located along and surrounding a substantial portion of the first drive chain between the first drive sprocket and the elastic tensioner cable, the connection between the first drive chain and the elastic tensioner cable, and a substantial portion of the elastic tensioner cable between the first drive chain and the idler pulley and
b. a second tubular housing located along and surrounding a substantial portion of the second drive chain between the second drive sprocket and the elastic tensioner cable, the connection between the second drive chain and the elastic tensioner cable, and a substantial portion of the elastic tensioner cable between the second drive chain and the idler pulley.

4. The vehicle propulsion system of claim 2, further comprising
a. a first tubular housing located along and surrounding a substantial portion of the first drive chain between the first drive sprocket and the elastic tensioner cable, the connection between the first drive chain and the elastic tensioner cable, and a substantial portion of the elastic tensioner cable between the first drive chain and the idler pulley and
b. a second tubular housing located along and surrounding a substantial portion of the second drive chain between the second drive sprocket and the elastic tensioner cable, the connection between the second drive chain and the elastic tensioner cable, and a substantial portion of the elastic tensioner cable between the second drive chain and the idler pulley.

5. The vehicle propulsion system of claim 1 wherein the idler pulley comprises a pulley pivotally attached to said vehicle frame in such a way that the pulley is free to rotated about its central axis.

6. The vehicle propulsion system of claim 2 wherein the idler pulley comprises a pulley pivotally attached to said vehicle frame in such a way that the pulley is free to rotated about its central axis.

7. The vehicle propulsion system of claim 1 wherein said elastic tensioner cable comprises continuous rubber strands with an outer Nylon sheath.

8. The vehicle propulsion system of claim 2 wherein said elastic tensioner cable comprises continuous rubber strands with an outer Nylon sheath.

9. The vehicle propulsion system of claim 6 wherein said elastic tensioner cable comprises continuous rubber strands with an outer Nylon sheath.

10. A human-powered vehicle comprising the vehicle propulsion system of claim 1.

11. A human-powered vehicle comprising the vehicle propulsion system of claim 2.

12. The vehicle of claim 10, further comprising the first tubular housing and the second tubular housing of claim 3.

13. The vehicle of claim 11, further comprising the first tubular housing and the second tubular housing of claim 3.

14. The vehicle of claim 10, further comprising
a. a seat fixed to the vehicle frame and located substantially aft of the pedal arms and
b. a seat back against which an operator of the vehicle may press to develop greater force against the pedals.

15. The vehicle of claim 11, further comprising
a. a seat fixed to the vehicle frame and located substantially aft of the pedal arms and
b. a seat back against which an operator of the vehicle may press to develop greater force against the pedals.

16. The vehicle of claim 10, wherein the axis about which the pedal arms rotate is located substantially below the pedals.

17. The vehicle of claim 11, wherein the axis about which the pedal arms rotate is located substantially below the pedals.

18. The vehicle of claim 10, wherein the axis about which the pedal arms rotate is located substantially above the pedals.

19. The vehicle of claim 11, wherein the axis about which the pedal arms rotate is located substantially above the pedals.

20. A power transmission device comprising
a. a rotatable shaft,
b. one or more engaging arms fixedly attached to said shaft,
c. a first disk, rotatable about a drive axle and capable of being engaged and moved by a change in position of the engaging arms,
d. two or more dowels protruding from the outboard face of the first disk,
e. a second disk fixedly attached to said drive axle
f. two or more hollow guides in said second disk through which said dowels pass,
g. a third disk comprising one hole for each of said dowels, said holes being engaged by said dowels when said first disk is moved toward said second and third disks, and
h. a drive wheel and corresponding hub, coupled to and freely rotatable about said drive axle, and fixedly attached to said third disk.
